(19) United States
(12) Patent Application Publication
(10) Pub. No.: US 2013/0297601 A1
(43) Pub. Date: Nov. 7, 2013

(54) Memory Recalling Device

(71) Applicant: Zishuo Li, Fremont, CA (US)

(72) Inventor: Zishuo Li, Fremont, CA (US)

(21) Appl. No.: 13/891,195

(22) Filed: May 10, 2013

(51) Int. Cl. G06F 17/30

(52) U.S. Cl. CPC G06F 17/30339
USPC 707/736

(57) ABSTRACT

A memory recalling system comprises a memory recalling device having a message collection module, a memory backup module operatively connected with the message collection module so as to receive a input message to generate historical memory assistance data, a memory assistance module operatively connected with the message collection module so as to receive a query message to find the answers for the query message, a storage module arranged to store the historical memory assistance data and the answers for the query message, an interaction and control module operatively connecting with a visual display indicator, the message collection module, and the memory assistance module and the memory backup module. In addition, the memory recalling system further comprises a remote terminal storage wireless connected with the memory recalling device wherein the remote terminal storage is arranged to store the historical assistance memory data from the storage module.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a memory recalling system, and more particularly to a memory recalling device, such as a mobile phone and PDA, wherein the memory recalling device is able to not only take a paperless note, but also help an user to recall his/her memory.

2. Description of Related Arts

The memory capability of human brain is limited, so most people sometimes forget the important thing with time passing. Therefore, most people made a record on paper so as to avoid forgetting the important thing. However, there are several drawbacks about making a record on paper. It is time-consuming to search the paper record document, and difficult to recognize handwritten. In other words, when an individual want to make a note, he/she must carry on a pen and papers with them, so that it is inconvenient for the user. In addition, an individual must has a lot of space to store the paper record document.

In order to solve the above-mentioned problem, a memory recalling device is needed so that the user is able to make a paperless record immediately. The memory recalling device is portable and time-saving, so the user is very easy to carry on the memory recalling device. This invention can be applied on mobile terminal device, such as a mobile phone, PDA, and a notebook type PC. Therefore, an user can input data messages and keywords information into the memory recalling device, so an user can search the data messages and keywords information when an user has already forgotten it. Especially, the memory recalling device is wirelessly connected with the remote terminal storage so as to prevent the problem of out of space.

### SUMMARY OF THE PRESENT INVENTION

A main object of this invention is to provide a memory recalling system comprising memory recalling device which is adapted for not only storing an input message, such as voice and video image, but also answering the query messages, and a remote terminal storage adapted for storing input and query message.

Another object of the invention is to provide a memory recalling device with a message collection module which is able to collect a variety types of input and query message, such as words, voice and video image so as to avoid recognizing scratchy handwriting.

Another object of the invention is to provide a memory recalling device with a memory backup module, wherein the memory back up module is able to analyze the input and query message to generate historical memory assistance data.

Another object of the invention is to provide a memory recalling device with a memory recalling module, wherein the memory recalling module is able to automatically matching the query message with the historical memory assistance data in order to find the answers for the query message.

Another object of the invention is to provide a memory recalling device with a storage module which is arranged to store the historical memory assistance data, so that the present invention successfully provide efficient way to decrease the space needed of paperless recording

Another object of the invention is to provide a memory recalling device with a visual display indicator, wherein the answers for the query message can be display on the visual display indicator for facilitating the practical use of the present invention.

Another advantages and features of the invention will become apparent from the description which follows, and may be realized by means of the instrumentalities and combinations particular point out in the appended claims.

These and other objectives, features, and advantages of the present invention will become apparent from the following detailed description, the accompanying drawings, and the appended claims.

### BRIEF DESCRIPTION OF THE DRAWINGS

FIG. 1 is a diagram of the memory recalling system with a memory recalling device according to a preferred embodiment of the present invention.

FIG. 2 is a diagram of the interaction and control module with a memory backup unit, a memory recalling unit, and a cancel unit, according to the above preferred embodiment of the present invention.

FIG. 3 is a diagram of the interaction and control module with a visual display indicator according to the preferred embodiment of the present invention.

FIG. 4 is a diagram of the memory recalling system wirelessly connecting with a remote terminal storage.

### DETAILED DESCRIPTION OF THE PREFERRED EMBODIMENT

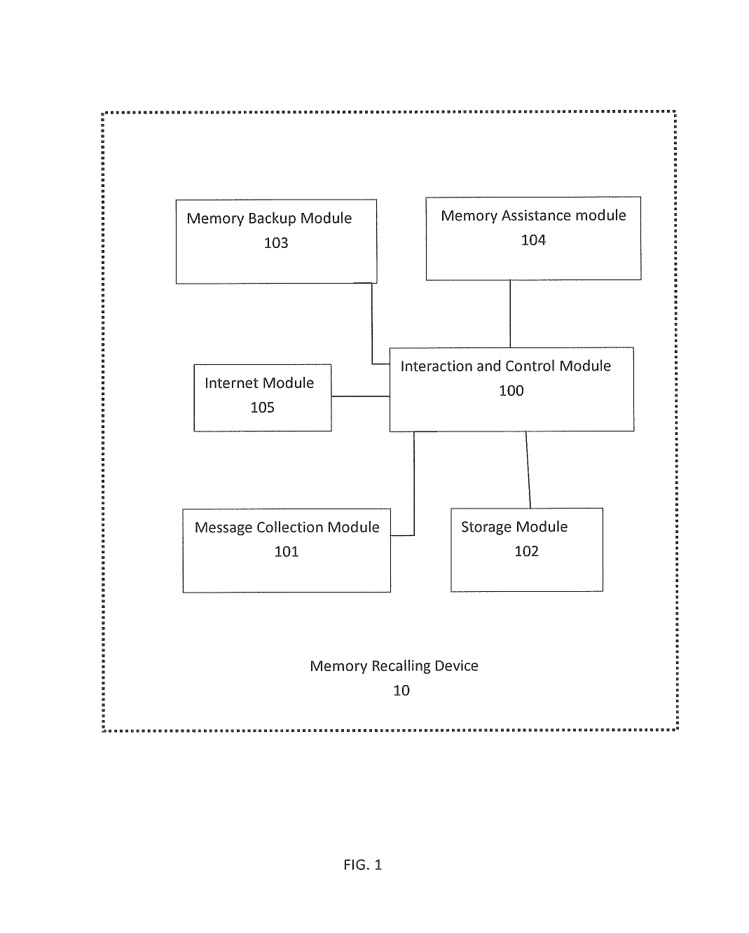

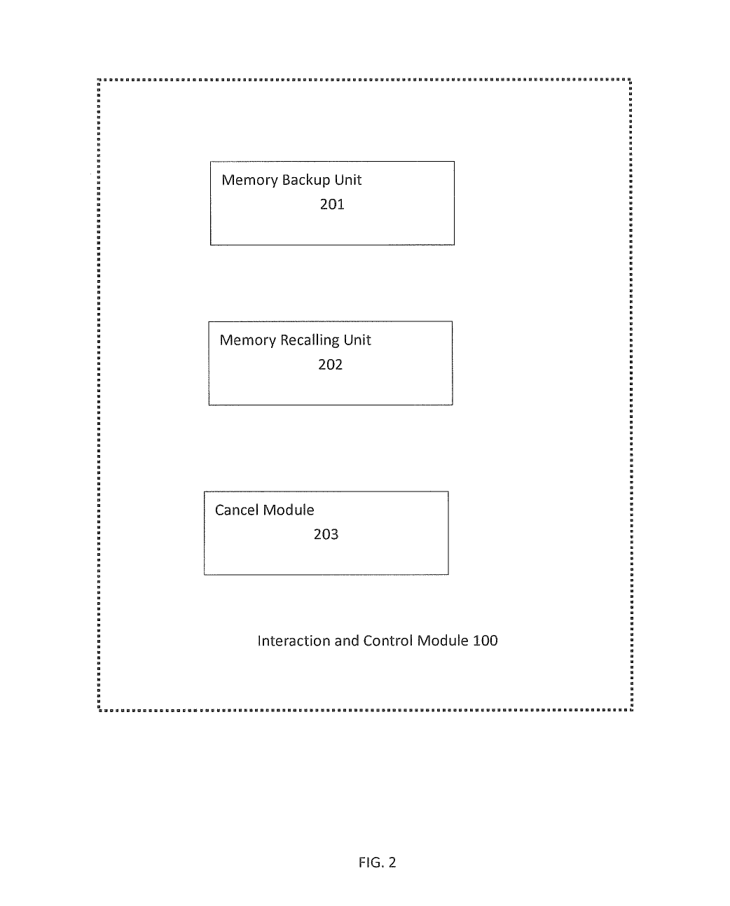

Referring to FIGS. 1 to 2, a memory recalling system according to preferred embodiment of the present invention is illustrated, wherein the memory recalling system comprises a memory recalling device 10 and a remote terminal storage 30.

The memory recalling device comprises a message collection module 101, a memory assistance module 104, a memory backup module 103, an interaction and control module 100, a storage module 102, and an internet module 105. The message collection module 101 is adapted for collecting the input message providing by an individual, and then sending the input message to the memory backup module 103. According to analyze the keywords from the input message, such as time, location, character, and activities. The memory backup module 103 is able to generate historical memory assistance data so as to store into the storage module 102.

According to the preferred embodiment of the present invention, an individual can input a query message to the message collection module 101 so as to send the query message to the memory assistance module 104. The memory assistance module 104 is able to receive the query message, and then automatically match the query message with historical memory assistance data in order to find the answers for the query message. After that, the answers are being sending to the interaction and control module 100. Moreover, the message collection module 101 is able to recognize the voice, image and video. In other words, the message collection module 101 is able to not only recognize the location based on the background voice, but also take a picture and record a video.

Referring to FIG. 2, the interaction and control module 100 comprises a memory backup unit 201, a memory recalling unit 202, and a cancel unit 203. The memory backup unit 201 can drive the message collection module 101 to collect the input message so as to transmit the input message to the memory backup module in order to generate historical memory assistance data. Moreover, the memory recalling unit 202 can drive the message collection module 101 to collect the query message so as to transmit the query message to the memory assistance module 104. Alternatively, the cancel unit 203 can drive to stop all executing action, such as the action driven by the memory backup unit 201 and the memory recalling unit 202.

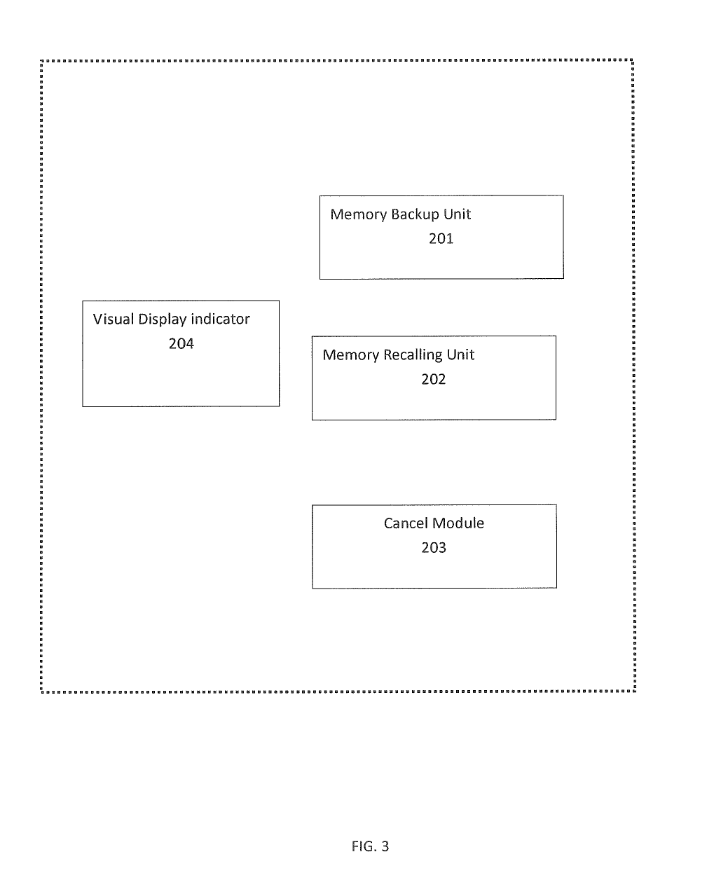

Referring to FIG. 3, the memory recalling device 10 further comprises a visual indicator 204 operatively connected to the interaction and control module 100 so as to display the answers for the query message.

It is worth to mention that the interaction and control module 100 is capable of automatically activating the message collection module 101 and memory backup module 103 after the memory assistance module 104 being activated, so as to backup the input message and query message.

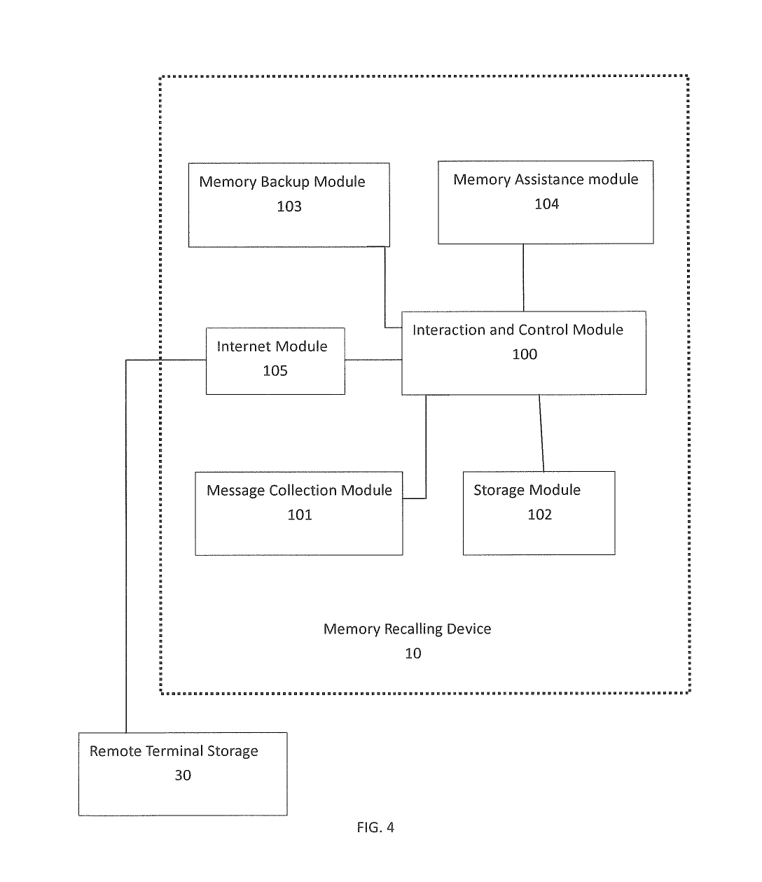

FIG. 4 illustrates the memory recalling system comprising the internet module 105 to wirelessly connect with the remote terminal storage 30, wherein the remote terminal storage 30 is arranged to store the historical assistance memory data from the storage module 102.

This invention can be applied mobile terminal devices, such as a mobile phone, PDA, a notebook type PC, and a mobile video device, so that the mobile terminal devices are able to back up the input and query message, and assist to evoke users' memory.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A memory recalling system, comprising:
a memory recalling device;
wherein said recalling device comprises:
a message collection module;
a memory backup module operatively connected with said message collection module so as to receive a input message to generate historical memory assistance data;
a memory assistance module operatively connected with said message collection module so as to receive a query message to find the answers for the query message;
a storage module arranged to store said historical memory assistance data and the answers for the query message;
a interaction and control module operatively connecting with a visual display indicator, said message collection module, said memory assistance module and said memory backup module; and
wherein said memory recalling system further comprises:
a remote terminal storage wireless connected with said memory recalling device wherein the remote terminal storage is arranged to store the historical assistance memory data from said storage module.

2. The memory recalling device, as recited in claim 1, wherein said input message is the time of event happening.

3. The memory recalling device, as recited in claim 1, wherein said input message is the noun of the input message.

4. The memory recalling device, as recited in claim 1, wherein said input message is a location.

5. The memory recalling device, as recited in claim 1, wherein said input message is the information of a character.

6. The memory recalling device, as recited in claim 1, wherein said input message is an activity, event, assembly and a party.

7. The memory recalling device, as recited in claim 1, wherein said message collection module is able to recognize the voice, image and video.

8. The memory recalling device, as recited in claim 1, wherein said message collection module is able to take a picture and record a video.

9. The memory recalling device, as recited in claim 1, wherein said visual display indicator is arranged to display the answers for the query message.

10. The memory recalling device, as recited in claim 1, wherein said interaction and control module is capable of automatically activating said message collection module and said memory backup module after said memory assistance module being activated, so as to back up said input message and said query message.

11. The memory recalling device, as recited in claim 1, wherein said interaction and control module comprises a memory backup unit , a memory recalling unit, and a cancel unit , wherein said memory backup unit can drive to collect said input message to generate said historical memory assistance data, wherein said memory recalling unit can drive to collect the query message so as to transmit said query message to said memory assistance module, wherein said cancel unit can drive to stop all executing action driven by said memory backup unit and the memory recalling unit.

12. The memory recalling module, as recited in claim 1, wherein said interaction and control operatively connecting with said storage module so as to store said historical memory assistance data.

13. The memory recalling module, as recited in claim 1, wherein said storage module wirelessly connecting with said remote terminal storage so that said historical memory assistance data are stored in said remote terminal storage.
